(19) United States
(12) Patent Application Publication
(10) Pub. No.: US 2017/0307839 A1
(43) Pub. Date: Oct. 26, 2017

(54) Surface Treated Optical Fibers And Cables For Installation At Customer Premises

(71) Applicant: OFS Fitel, LLC, Norcross, GA (US)

(72) Inventors: Kelvin B. Bradley, Lawrenceville, GA (US); Valerie A. Hill, Villa Rica, GA (US); Peter A. Weimann, Atlanta, GA (US)

(73) Assignee: OFS Fitel, LLC, Norcross, GA (US)

(21) Appl. No.: 15/253,914

(22) Filed: Sep. 1, 2016

Related U.S. Application Data
(60) Provisional application No. 62/327,712, filed on Apr. 26, 2016.

(51) Int. Cl. G02B 6/44; G02B 6/46

(52) U.S. Cl. CPC G02B 6/4486; G02B 6/46; G02B 6/443; G02B 6/4436

(57) ABSTRACT

A method of treating a buffered optical fiber or jacketed cable having a relatively low surface energy, e.g., fibers or cables that meet low smoke zero halogen (LSZH) standards, so they can be bonded to a supporting substrate at a customer premises by a water soluble, non-flammable adhesive. One or more burners produce a flame that treats the surface of the fiber or cable by oxidizing the surface as the fiber or cable moves past the burners. The surface energy increases enough for the adhesive to wet the surface so that, when cured, the adhesive bonds the fiber or cable to the supporting substrate. In another embodiment, a blown-ion discharge is directed at a determined rate over the surface of the fiber or cable, thereby treating the surface by removing contamination and micro-etching, and increasing the surface energy enough for the adhesive to wet the surface.

### CROSS REFERENCE TO RELATED APPLICATION

This application claims priority under 35 U.S.C. §119(e) of U.S. Provisional Patent Application No. 62/327,712 filed Apr. 26, 2016, titled “Surface Treated Cables for Installation at Customer Premises,” the entire contents of which are incorporated by reference.

### BACKGROUND OF THE INVENTION

### Field of the Invention

The present invention relates to optical fibers and cables, particularly fibers and cables intended for installation at customer premises.

### Discussion of the Known Art

The deployment of desktop optical network terminals (ONTs) inside the homes of network users is increasing. ONTs can be conveniently located close to a TV set top box or an Internet modem. An optical fiber routed inside the home connects the ONT to a service module usually installed at an entrance to the home by the network provider. The in-home fiber routing is preferably performed at minimal cost and with little, if any, visibility when completed.

While staples may sometimes be used to route a fiber along a wall, molding, or other supporting surface in a user's home in least time and at low cost, users often prefer instead to hide the fiber completely from view by way of special moldings or conduits. Also, if not properly struck, staples can impair or break the fiber and physically damage walls and moldings as well. Thus, for customers who prefer to hide all cables and fibers routed inside their premises entirely from view, expensive hardware and increased installation time are required.

A procedure that allows an installer to route and bond an optical fiber or cable quickly, safely, and permanently to exposed surfaces, grooves and/or corners inside a customer premises so the finished installation leaves little or no visual impact, is therefore very desirable. Materials and instructions for performing such an installation are currently available from OFS Fitel, LLC, under the registered mark InvisiLight®. See U.S. Pat. No. 8,906,178 (Dec. 9, 2014) and U.S. Pub. No. 2016/0097911 (Apr. 7, 2016), both of which are incorporated by reference. During an InvisiLight installation, a consumer grade, low odor, nonhazardous, water based adhesive is used to bond PVC buffered fibers or PVC jacketed indoor cables, to walls, ceilings, and other substrates over a routing path inside the premises. Water based adhesives are desirable since they can be applied in areas having little or no ventilation, cleaned up with soap and water, and shipped worldwide without restrictions.

As demand for indoor deployments like InvisiLight spreads from North America into Europe, regional building standards impose certain constraints on the product offering. In Europe, the Middle East, and Africa (the EMEA region), safety standards often require the use of low smoke zero halogen (LSZH) jacketed optical fibers and cables for indoor installations. Materials commonly used in the manufacture of LSZH cables are typically mineral-filled compounds based on low surface energy (LSE) plastics including thermoplastic polyolefins, thermoplastic urethanes, and thermoplastic polyester elastomers. For example, a LSZH compliant 2.0 mm diameter cable produced by OFS Fitel, LLC for use in Europe uses an olefinic outer jacket having a surface energy of less than 31 dyne/cm, while PVC cable jackets have surface energies typically in the mid to high 30's dyne/cm.

Polyolefin materials typically have a chemically inert surface that makes them useful in many applications, but their low surface energy makes it difficult to bond the materials chemically or mechanically to another surface. An adhesive for bonding a polyolefin jacketed cable to a supporting substrate must therefore be able to wet the jacket and penetrate it enough to produce a secure and permanent mechanical connection with the substrate once the adhesive cures. For the adhesive to wet the surface of the cable jacket sufficiently, it should exhibit a surface tension that is equal to or lower than that of the jacket. See, Adhesion Bonding, “Surface Wetting and Pretreatment Methods,” at www.adhesionbonding.com/2012/05/04/surface-wetting/. And while such adhesives exist, they (i) are expensive, (ii) are usually provided in two parts that must be mixed in a specific ratio, (iii) do not conform with local codes for living residences, and/or (iv) require a hot melt or other special procedure to prepare, apply, and cure. See, e.g., U.S. Pat. No. 8,921,485 (Dec. 30, 2014), and U.S. Pubs No. 2016/0075924 (Mar. 17, 2016) and No. 2016/0102230 (Apr. 14, 2016).

Surface treatment of polyolefin material by the application of ultraviolet radiation or an oxidizing gas flame to improve adhesion of ink on the material, is known. See U.S. Pat. No. 4,933,123 (Jun. 12, 1990), and No. 5,223,852 (Jun. 29, 1993). It is also known to irradiate the surface of a polyolefin article with a plasma to improve adhesion to the surface. See U.S. Pat. No. 4,465,715 (Aug. 14, 1984), and No. 5,324,771 (Jun. 28, 1994). As far as is known, however, a surface treatment for a LSE optical fiber or cable that enables a water based, consumer grade, non-flammable adhesive to bond the fiber securely on the surface of a supporting substrate has not been disclosed.

### SUMMARY OF THE INVENTION

According to the invention, a method of treating a length of a buffered optical fiber or a jacketed cable having a relatively low surface energy so that the fiber or cable can be bonded to a surface on a supporting substrate at a customer premises by an adhesive, includes providing one or more burners for producing a flame, and directing the flame over a surface on the fiber or cable, thereby treating the fiber or cable by oxidizing the surface. The burners and the fiber or cable are arranged to move relative to one another at a determined rate so that the surface energy of the fiber or cable is increased by an amount sufficient for wetting by a water soluble, non-flammable adhesive for bonding the fiber or cable to a supporting substrate.

According to another aspect of the invention, a method of treating a length of a buffered optical fiber or a jacketed cable having a relatively low surface energy so that the fiber or cable can be bonded to a surface on a supporting substrate at a customer premises by an adhesive, includes producing a blown-ion discharge and directing the discharge over a surface on the fiber or cable, thereby treating the wire or cable by removing contamination and micro-etching the surface. The blown-ion discharge and the fiber or cable are arranged to move relative to one another at a determined rate so that the surface energy of the fiber or cable is increased by an amount sufficient for wetting by a water soluble, non-flammable adhesive for bonding the fiber or cable to a supporting substrate.

According to yet another aspect of the invention, a length of fiber optic cable includes an outer cable jacket of a low smoke zero halogen (LSZH) material selected from among polyolefins, urethanes, and polyester elastomers, wherein the material is treated to have an increased surface energy capable of wetting by a water soluble, non-flammable adhesive for bonding the cable to a supporting substrate inside a customer premises.

According to a further aspect of the invention, a length of buffered optical fiber includes a buffer layer of a low smoke zero halogen (LSZH) material selected from among polyolefins, urethanes, and polyester elastomers, wherein the material is treated to have an increased surface energy capable of wetting by a water soluble, non-flammable adhesive for bonding the cable to a supporting substrate inside a customer premises.

For a better understanding of the invention, reference is made to the following description taken in conjunction with the accompanying drawing and the appended claims.

### BRIEF DESCRIPTION OF THE DRAWING FIGURES

In the drawing:

FIG. 1 is a graph showing peel test results for 900 micron low smoke zero halogen (LSZH) buffered fibers prior to a flame surface treatment;

FIG. 2 is a graph showing peel test results for untreated 900 micron PVC buffered fibers;

FIG. 3 is a graph showing peel test results for 900 micron LSZH buffered fibers after the fibers are flame surface treated according to the invention;

FIG. 4 is a graph of peel test results for 2.0 mm LSZH cordage prior to a flame surface treatment; and

FIG. 5 is a graph of peel test results for 2.0 mm LSZH cordage after the cordage was flame surface treated according to the invention.

### DETAILED DESCRIPTION OF THE INVENTION

According to the invention, burner flame and blown-ion surface treatments are used to increase the surface energy of buffered optical fibers or jacketed cables including those conforming to low smoke zero halogen (LSZH) standards, so that a commercially available, non-hazardous, water-based consumer grade adhesive can be used to bond the fibers or cables permanently to surfaces of walls, ceilings, and other supporting substrates inside a customer premises with little or no visual impact. In particular, the invention permits cost effective installations to be performed at premises where LSZH compliant fibers and cables are mandated.

To enable the adhesive to wet and penetrate LSZH and other low surface energy (LSE) fibers and cables enough to bond them firmly on a supporting substrate when the adhesive cures, the fibers or cables are exposed to either a flame treatment or a plasma (a/k/a “blown-ion”) process to increase their surface energy. Flame treatment increases surface energy by causing surface oxidation which improves chemical functionality. Blown-ion treatment increases surface energy by bombarding the surface with a high speed discharge of positive ions that have a micro-etching or scrubbing effect, thereby removing contamination and increasing the polarity of the surface.

Other treatment methods are also known generally to increase the surface energy of materials, for example, solvent cleaning, priming, surface roughening, and acid etching. Flame and blown-ion treatment are preferred as being most practical and cost effective for buffered fibers and jacketed cables, since either treatment may be implemented fairly seamlessly during the course of a typical production run of a LSZH fiber or cable.

### Evaluations of Flame Surface Treatments

0.9 mm (900 micron) LSZH Buffered Fiber

Samples of LSZH buffered fibers were obtained by applying a tight buffer layer of PolyOne ECCOH™ 6151 polyolefin material around each of several 250 micron fibers, to obtain an outer diameter of 900 microns for each fiber. Control samples of PVC buffered fibers were also obtained.

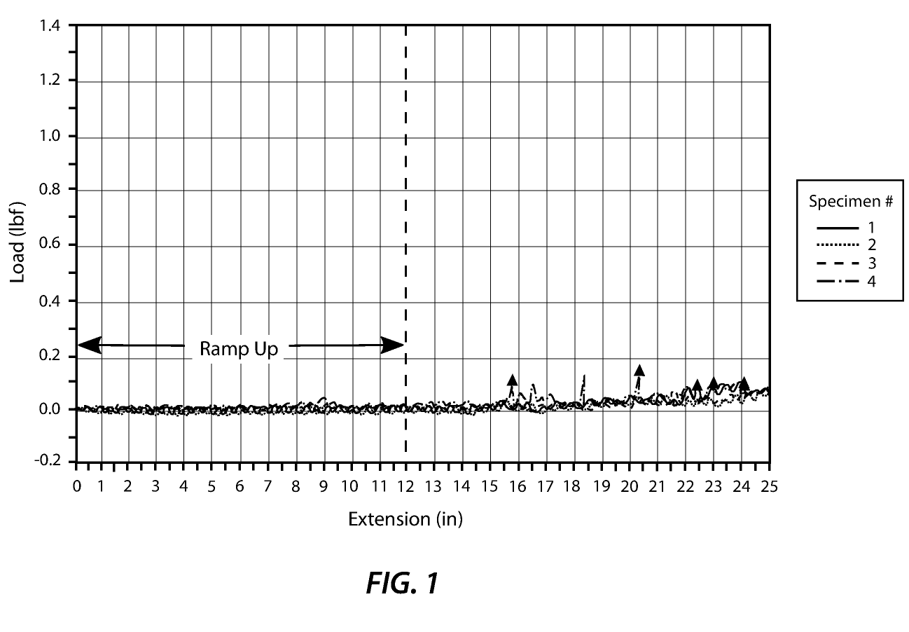

FIG. 1 shows peel test results for the LSZH buffered fibers prior to being treated, and after the fibers were adhered on the surface of a painted wood substrate using a one part, water soluble, commercially available non-flammable indoor adhesive in the form of an acrylic polymer paste. When cured, the adhesive should bond to surfaces of both painted and unpainted supporting substrates commonly found in indoor premises, e.g., wood, sheet rock, wall paper, brick, cinder block, concrete block, and cement. The adhesive can be cleaned up with soapy water, and it becomes clear after drying.

Load results obtained during “Ramp Up” in FIGS. 1 to 5 were disregarded, since the pull angle of the fibers relative to the surface of the substrate was well below 90 degrees. Load units are in pound-force (lbf).

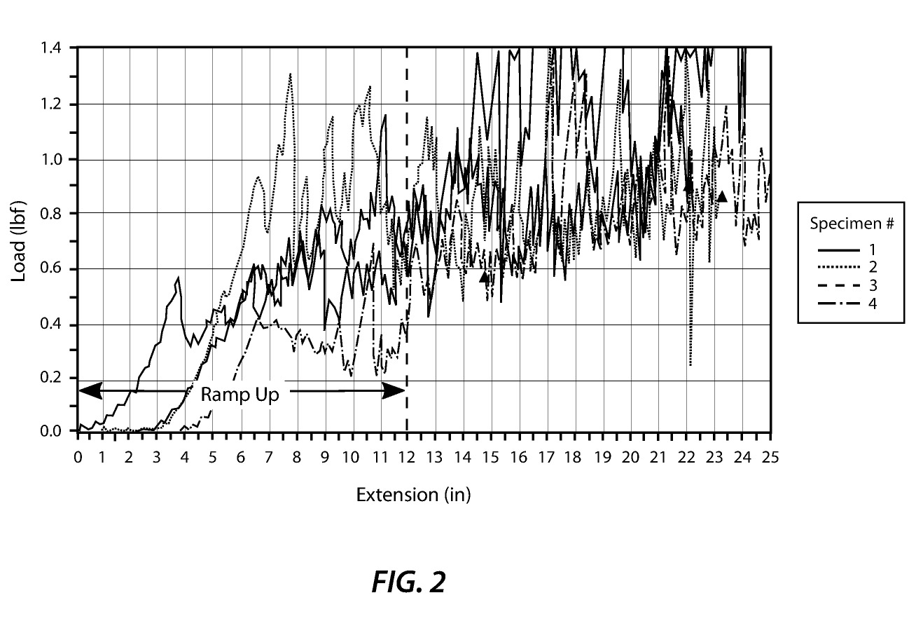

In the results shown in FIG. 1, the untreated fibers exhibit virtually no bonding to the substrate since the adhesive is not able to “wet out” the low surface energy LSZH material adequately. By contrast, FIG. 2 shows results for the PVC buffered fibers which have inherently higher surface energy. As seen in FIG. 2, the PVC buffered fibers bond very well to substrate using the same adhesive, requiring an average load of about 0.8 lbf to pull away from the substrate.

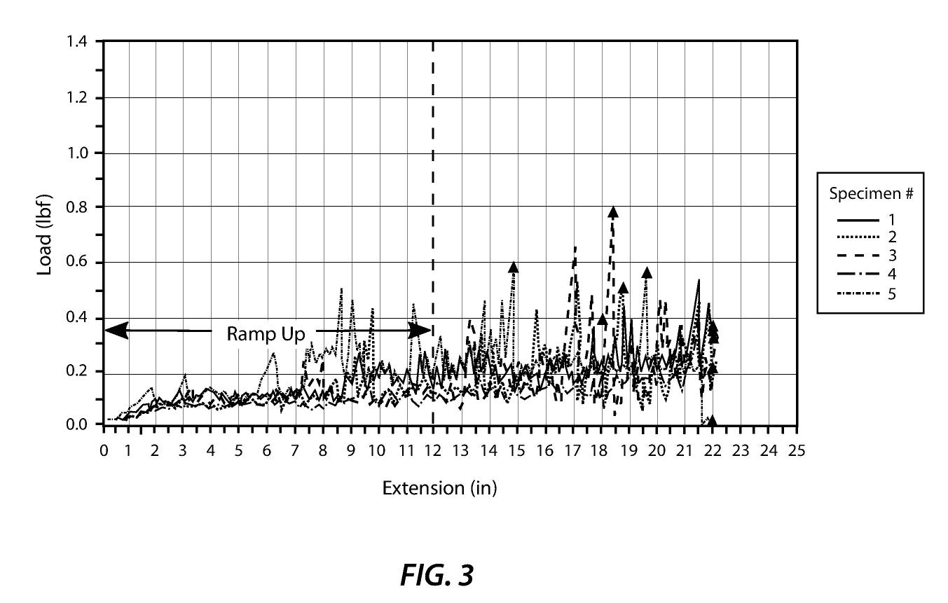

FIG. 3 shows peel test results for the 900 micron LSZH buffered fibers, after the fibers were passed at a line speed of approximately 20 meters per minute between a pair of burners arranged to face one another. Each burner directed a natural gas flame toward a corresponding side of the passing fiber to ensure the surface of the fiber was treated evenly about its circumference. Air pressure was set to 1.5 psi to achieve a sharp blue flame. As seen in FIG. 3, the flame treated buffered fibers exhibit noticeably better bonding to the substrate than the untreated fibers in FIG. 1 when using the same adhesive.

### 2.0 mm LSZH Cordage

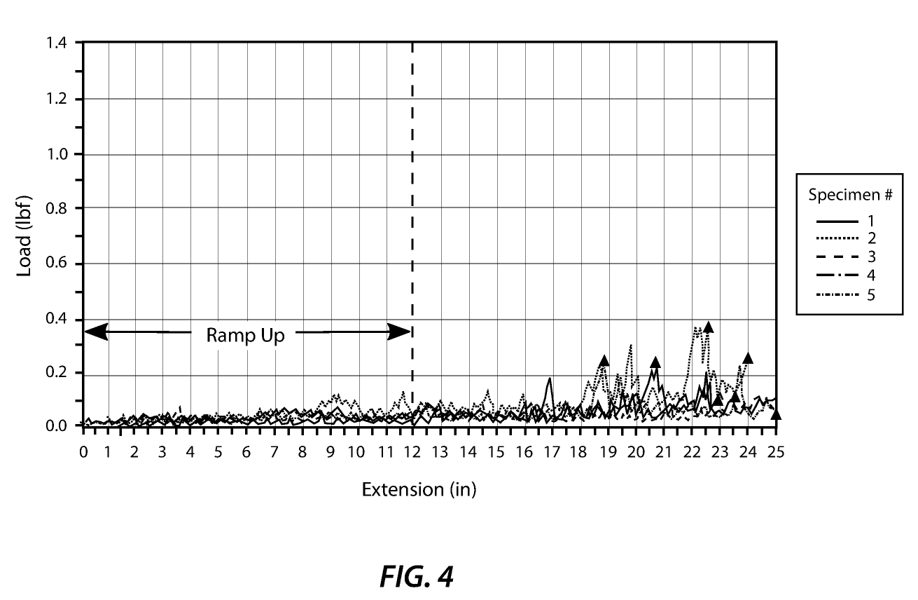

Prior to flame treatment, sample lengths of 2.0 mm LSZH cordage having an outer jacket of AlphaGary MEGOLON™ 8142 polyolefin material were adhered on the surface of the painted wood substrate, using the above mentioned water soluble paste adhesive. In peel test results shown in FIG. 4, the untreated cordage samples exhibit virtually no bonding to the substrate since the adhesive is unable to wet the low-energy LSZH cable jacket adequately.

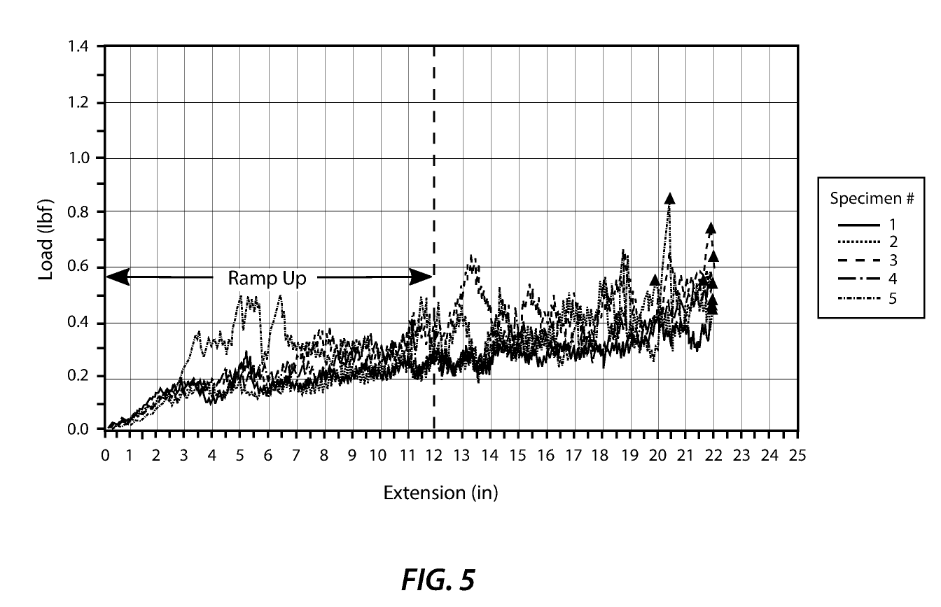

By contrast, FIG. 5 shows peel test results after the 2.0 mm cordage samples were flame treated in the same manner as the LSZH buffered fibers, above. As seen in FIG. 5, the treated cordage samples exhibit noticeably better bonding to the substrate than the untreated samples in FIG. 4 when using the same adhesive.

### Evaluations of Blown-ion Surface Treatments

Blown-ion air plasma systems push pressurized air past a single electrode which discharges inside a treater head. The discharge creates positively charged ions from surrounding air particles inside the head. Air pressure supplied to the head forces the charged ions to accelerate from a tip of the head as a high velocity ion stream. When directly contacting the surface of an object, the ion stream positively charges the surface thereby increasing the surface energy.

Four types of LSZH buffered fibers were prepared by applying a tight buffer layer of one of four LSZH compounds around each of a number of 250 micron fibers, to obtain an outer diameter of 900 microns for each fiber. The LSZH compounds included polyolefin, polyester, and urethane. Blown-ion surface treatments were performed on each of the buffered fibers using an Enercon Industries blown-ion plasma surface treater. The fibers moved through the ion discharge from the treatment head of the treater at a line speed of approximately 50 meters per minute. Peel tests were then performed on each of the four types of buffered fibers (i) before treatment, (ii) after a length of the fiber passed once through the ion discharge from surface treater, and (iii) after the fiber passed three times through the ion discharge.

Peel test results were obtained after adhering specimens of each type of buffered fiber to a painted wood substrate using the one part, water-soluble, consumer grade indoor adhesive noted above. As mentioned, 900 micron non-LSZH, PVC buffered fibers were adhered to a painted wood substrate with the same adhesive to act as a control sample. The adhesive was allowed to cure for 24 hours, and the load needed to pull each of the adhered fibers away from the substrate at a 90-degree angle was measured. The results for the PVC control samples are shown in FIG. 2. The average load to peel the PVC buffered fibers was 0.8 lbf.

### EXAMPLE ONE

Buffered 900 micron fibers were prepared each with a PolyOne ECCOH™ 6151 LSZH polyolefin tight buffer layer, and the fibers were adhered without surface treatment to the wood substrate together with the PVC buffered control fiber as described above. After allowing the adhesive to cure 24 hours, the following results were obtained:
Average Load to Peel PVC Buffered Fiber: 0.8 pound-force (lbf)
Average Load to Peel Untreated ECCOH Buffered Fibers: <0.1 lbf

### EXAMPLE TWO

Buffered 900 micron fibers were prepared each with a PolyOne ECCOH 6151 LSZH polyolefin tight buffer layer, and passed once through the blown-ion discharge from the surface treater as noted above. The treated fibers were adhered to the wood substrate. After allowing the adhesive to cure 24 hours, the following results were obtained:
Average Load to Peel PVC Buffered Fiber: 0.8 lbf
Average Load to Peel 1× Treated ECCOH Buffered Fiber: ˜0.4 lbf

### EXAMPLE THREE

Buffered 900 micron fibers were prepared with a PolyOne ECCOH 6151 LSZH polyolefin tight buffer layer, and passed three times through the blown-ion discharge from the surface treater as noted above. The treated fibers were adhered to the wood substrate. After allowing the adhesive to cure 24 hours, the following results were obtained:
Average Load to Peel PVC Buffered Fiber: 0.8 lbf
Average Load to Peel 3× Treated ECCOH Buffered Fiber: ˜0.5 lbf

### EXAMPLE FOUR

Buffered 900 micron fibers were prepared with a tight buffer layer of a polyester elastomer comprised of a blend of DuPont HYTREL® 6356 with HYTREL 52R added at 10 wt %, and adhered without surface treatment to the wood substrate. After allowing the adhesive to cure 24 hours, the following results were obtained:
Average Load to Peel PVC Buffered Fiber: 0.8 lbf
Average Load to Peel Untreated HYTREL Buffered Fiber: ˜0.15 lbf

### EXAMPLE FIVE

Buffered 900 micron fibers were prepared with a tight buffer layer of a polyester elastomer comprised of a blend of DuPont HYTREL 6356 with HYTREL 52R added at 10 wt %, and passed once through the blown-ion discharge from the surface treater as noted above. The treated fibers were adhered to the wood substrate. After allowing the adhesive to cure 24 hours, the following results were obtained:
Average Load to Peel PVC Buffered Fiber: 0.8 lbf
Average Load to Peel 1× Treated HYTREL Buffered Fiber: ˜0.5 lbf

### EXAMPLE SIX

Buffered 900 micron fibers were prepared with a tight buffer layer of a polyester elastomer comprised of a blend of DuPont HYTREL® 6356 with HYTREL 52R added at 10 wt %, and passed three times through the blown-ion discharge from the surface treater as noted above. The treated fibers were adhered to the wood substrate. After allowing the adhesive to cure 24 hours, the following results were obtained:
Average Load to Peel PVC Buffered Fiber: 0.8 lbf
Average Load to Peel 3× Treated HYTREL Buffered Fiber: ˜0.5 lbf

### EXAMPLE SEVEN

Buffered 900 micron fibers were prepared with an AlphaGary MEGOLON™ 8142 LSZH polyolefin tight buffer layer, and adhered without surface treatment to the wood substrate. After allowing the adhesive to cure 24 hours, the following results were obtained:
Average Load to Peel PVC Buffered Fiber: 0.8 lbf
Average Load to Peel Untreated MEGOLON Buffered Fiber: ˜0.1 lbf

### EXAMPLE EIGHT

Buffered 900 micron fibers were prepared with an AlphaGary MEGOLON 8142 LSZH polyolefin tight buffer layer, and passed once through the blown-ion discharge from the surface treater as noted above. The treated fibers were adhered to the wood substrate. After allowing the adhesive to cure 24 hours, the following results were obtained:
Average Load to Peel PVC Buffered Fiber: 0.8 lbf
Average Load to Peel 1× Treated MEGOLON Buffered Fiber: ˜0.3 lbf

### EXAMPLE NINE

Buffered 900 micron fibers were prepared with an AlphaGary MEGOLON 8142 LSZH polyolefin tight buffer layer, and passed three times through the blown-ion discharge from the surface treater as noted above. The treated fibers were adhered to the wood substrate. After allowing the adhesive to cure 24 hours, the following results were obtained:
Average Load to Peel PVC Buffered Fiber: 0.8 lbf
Average Load to Peel 3× Treated MEGOLON Buffered Fiber: ˜0.4 lbf

### EXAMPLE TEN

Buffered 900 micron fibers were prepared with a Huntsman Corp. IROGRAN® A95P5003 LSZH urethane tight buffer layer, and adhered without surface treatment to the wood substrate. After allowing the adhesive to cure 24 hours, the following results were obtained:
Average Load to Peel PVC Buffered Fiber: 0.8 lbf
Average Load to Peel Untreated IROGRAN Buffered Fiber: <0.1 lbf

### EXAMPLE ELEVEN

Buffered 900 micron fibers were prepared with a Huntsman Corp. IROGRAN A95P5003 LSZH urethane tight buffer layer, and passed once through the blown-ion discharge from the surface treater as noted above. The treated fibers were adhered to the wood substrate. After allowing the adhesive to cure 24 hours, the following results were obtained:
Average Load to Peel PVC Buffered Fiber: 0.8 lbf
Average Load to Peel 1× Treated IROGRAN Buffered Fiber: ˜0.25 lbf

### EXAMPLE TWELVE

Buffered 900 micron fibers were prepared with a Huntsman Corp. IROGRAN A95P5003 LSZH urethane tight buffer layer, and passed three times through the blown-ion discharge from the surface treater as noted above. The treated fibers were adhered to the wood substrate. After allowing the adhesive to cure 24 hours, the following results were obtained:
Average Load to Peel PVC Buffered Fiber: 0.8 lbf
Average Load to Peel 3× Treated IROGRAN Buffered Fiber: ˜0.3 lbf

The foregoing Examples demonstrate that all four types of untreated LSZH buffered fibers exhibit virtually no adhesion to the wood substrate when the applied adhesive cures, since the adhesive does not sufficiently “wet out” and penetrate the buffer layers of the untreated fibers. By contrast, the same adhesive bonds the PVC buffered control fiber very well to the substrate because of the higher surface energy of the fiber.

When treated, however, all of the four types of LSZH buffered fibers are compatible with the applied adhesive and bond to the wood substrate in varying degrees, as follows:

The ECCOH and HYTREL samples (Examples One to Six) exhibit significant responses, on average, to the 1× and 3× blown-ion surface treatments by bonding to the substrate with somewhat less strength than the PVC buffered control fibers.

The MEGOLON samples (Examples Seven to Nine) exhibit noteworthy responses, on average, to the 1× and 3× blown-ion treatments by bonding to the substrate with about half the strength as the PVC buffered control fibers.

The IROGRAN 1× and 3× blown-ion treated samples (Examples Ten to Twelve) bond to the substrate noticeably better than the untreated samples, but with less than half the strength of the PVC buffered control fibers.

When treated as described herein, the ability of LSZH optical fibers and cables to be installed at customer premises by the use of an inexpensive, water-based consumer grade adhesive will act to expand the number of premises worldwide in which installations like InvisiLight can be performed. The installation is simple, leaves little or no visual impact, and is likely to be accepted by most customers to be carried out at their premises.

While the foregoing represents preferred embodiments of the present invention, it will be understood by persons skilled in the art that various changes, modifications, and additions can be made without departing from the spirit and scope of the invention, and that the invention includes all such changes, modifications, and additions that are within the scope of the following claims.

We claim:

1. A method of treating a length of an optical fiber or cable having a relatively low surface energy so that the fiber or cable can be bonded to a surface of a supporting substrate at a customer premises by an adhesive, comprising:
providing one or more burners for producing a flame;
directing the flame from the burners over a surface on the length of fiber or cable, thereby treating the fiber or cable by oxidizing the surface; and
arranging the burners and the length of fiber or cable to move relative to one another at a determined rate during the directing step so that the surface energy of the fiber or cable is increased by an amount sufficient for wetting by a water soluble, non-flammable adhesive for bonding the fiber or cable to a supporting substrate inside a customer premises.

2. The method of claim 1, including applying the adhesive along a defined routing path on the surface of a supporting substrate, and urging the treated fiber or cable into the adhesive along the routing path on the substrate.

3. The method of claim 2, including allowing the adhesive to cure thereby bonding the treated fiber or cable to the substrate.

4. The method of claim 3, wherein the adhesive is clear when cured.

5. The method of claim 2, including selecting the supporting substrate from among painted or unpainted wood, sheet rock, wall paper, brick, cinder block, concrete block, and cement.

6. The method of claim 1, including selecting the length of optical fiber or cable to be treated from among low smoke zero halogen (LSZH) compliant fibers and cables.

7. The method of claim 1, including arranging a pair of the burners face to face with one another, and passing the fiber or cable at a rate of approximately 20 meters per minute between the pair of burners so that each burner directs a flame toward a corresponding side of the fiber or cable and treats the surface of the fiber or cable evenly about its circumference.

8. A method of treating a length of an optical fiber or cable having a relatively low surface energy so that the fiber or cable can be bonded to a surface of a supporting substrate at a customer premises by an adhesive, comprising:
producing a blown-ion discharge;
directing the blown-ion discharge over a surface on the length of fiber or cable, thereby treating the fiber or cable by removing contamination and micro-etching the surface; and
arranging the blown-ion discharge and the length of fiber or cable to move relative to one another at a determined rate during the directing step so that the surface energy of the fiber or cable is increased by an amount sufficient for wetting by a water soluble, non-flammable adhesive for bonding the fiber or cable to a supporting substrate inside a customer premises.

9. The method of claim 8, including applying the adhesive along a defined routing path on the surface of a supporting substrate, and urging the treated fiber or cable into the adhesive along the routing path on the substrate.

10. The method of claim 9, including allowing the adhesive to cure thereby bonding the treated fiber or cable to the substrate.

11. The method of claim 10, wherein the adhesive is clear when cured.

12. The method of claim 9, including selecting the supporting substrate from among painted or unpainted wood, sheet rock, wall paper, brick, cinder block, concrete block, and cement.

13. The method of claim 8, including selecting the length of optical fiber or cable to be treated from among low smoke zero halogen (LSZH) compliant fibers and cables.

14. The method of claim 8, moving the fiber or cable through the blown-ion discharge at a rate of approximately 50 meters per minute.

15. A length of fiber optic cable including an outer cable jacket of a low smoke zero halogen (LSZH) material selected from among polyolefins, urethanes, and polyester elastomers, wherein the material is treated to have an increased surface energy capable of wetting by a water soluble, non-flammable adhesive for bonding the cable to a supporting substrate inside a customer premises.

16. A length of fiber optic cable according to claim 15, wherein the outer cable jacket has a diameter of approximately 2.0 mm.

17. A length of buffered optical fiber including a buffer layer of a low smoke zero halogen (LSZH) material selected from among polyolefins, urethanes, and polyester elastomers, wherein the material is treated to have an increased surface energy capable of wetting by a water soluble, non-flammable adhesive for bonding the cable to a supporting substrate inside a customer premises.

18. A length of buffered optical fiber according to claim 17, wherein the buffer layer has an outer diameter of approximately 900 microns.
